(19) United States
(12) Patent Application Publication
(10) Pub. No.: US 2021/0318213 A1
(43) Pub. Date: Oct. 14, 2021

(54) DISASSEMBLY DEVICE

(71) Applicant: Goldtek Technology Co., Ltd., New Taipei City (TW)

(72) Inventors: LIH-SIN LEE, Taipei (TW); YU-YING CHEN, New Taipei (TW)

(73) Assignees: Goldtek Technology Co., Ltd., New Taipei City (TW); Goldtek Technology Co., Ltd., New Taipei City (TW)

(21) Appl. No.: 16/944,528

(22) Filed: Jul. 31, 2020

(30) Foreign Application Priority Data
Apr. 8, 2020 (TW) 109204027

(51) Int. Cl. G01N 3/08

(52) U.S. Cl. CPC G01N 3/08; G01N 2203/0017

(57) ABSTRACT

A disassembly device for disassembling a test object includes a first actuating portion and a second actuating portion. The first actuating portion is configured to fix a portion of the test object and apply a first pulling force on the test object. The second actuating portion is configured to fix another portion of the test object and apply a second pulling force on the test object. The first pulling force is opposite to the second pulling force.

### FIELD

The subject matter herein generally relates to disassembly devices, and more particularly to a disassembly device for disassembling a test object.

### BACKGROUND

Generally, after an object is made, functions of the object need to be tested. Some objects need to be disassembled during the testing process. However, the disassembly method in the related art generally uses tools such as wrenches and screwdrivers, which may damage the object.

### BRIEF DESCRIPTION OF THE DRAWINGS

Implementations of the present disclosure will now be described, by way of embodiments, with reference to the attached figures.

FIG. 1 is an assembled, isometric view of an embodiment of a disassembly device.

FIG. 2 is a partial exploded, isometric view of the disassembly device in FIG. 1.

FIG. 3 is an exploded, isometric view of the disassembly device in FIG. 2.

FIG. 4 is an isometric view of a test object.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

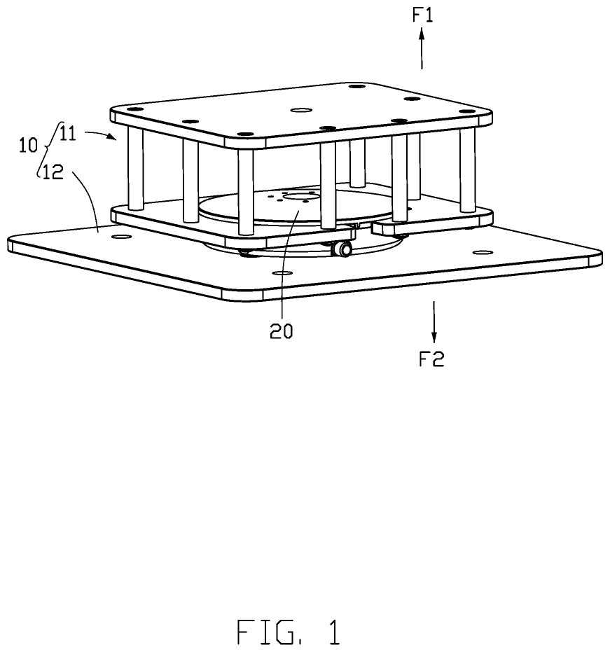

FIG. 1 shows an embodiment of a disassembly device 10 including a first actuating portion 11 and a second actuating portion 12. The first actuating portion 11 and the second actuating portion 12 are provided separately. The first actuating portion 11 and the second actuating portion 12 are used for fixing a test object 20. The test object 20 fixed by the disassembly device 10 is located between the first actuating portion 11 and the second actuating portion 12.

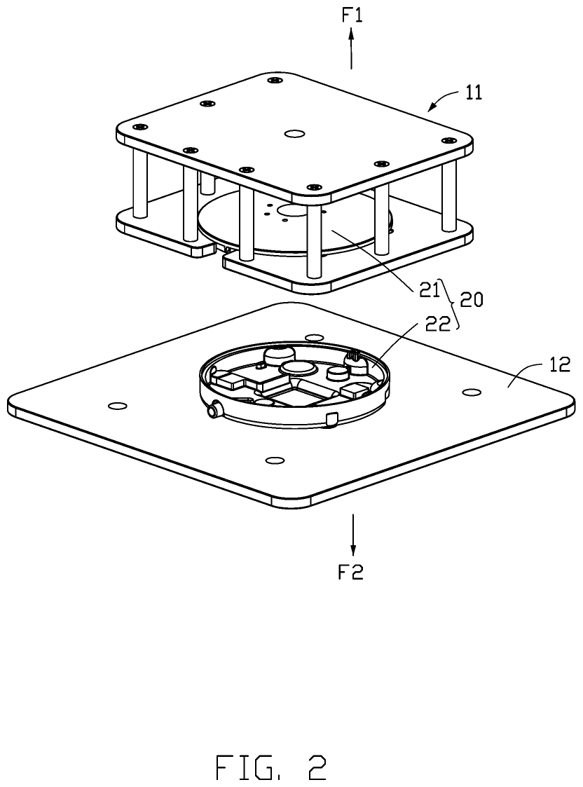

The first actuating portion 11 and the second actuating portion 12 fix different portions of the test object 20. The first actuating portion 11 applies a pulling force F1 on the test object 20, and the second actuating portion 12 applies a pulling force F2 on the test object 20 opposite the pulling force F1, thereby disassembling the test object 20. As shown in FIG. 2, a top cover 21 and a bottom cover 22 of the test object 20 are separated by the first actuating portion 11 and the second actuating portion 12.

The disassembly device 10 can be used for disassembling the test object 20 to be tested. In one embodiment, the test object 20 is a waterproof structure of a lens end of an outdoor walkie-talkie, which is formed by ultrasonic welding, and a welding strength can be tested by disassembling the test object 20 by the disassembly device 10. The higher the welding strength is, the better the waterproof performance. In one embodiment, the test object 20 is disassembled by the disassembly device 10, and values of the pulling force F1 and the pulling force F2 are between 30 and 50 kgf.

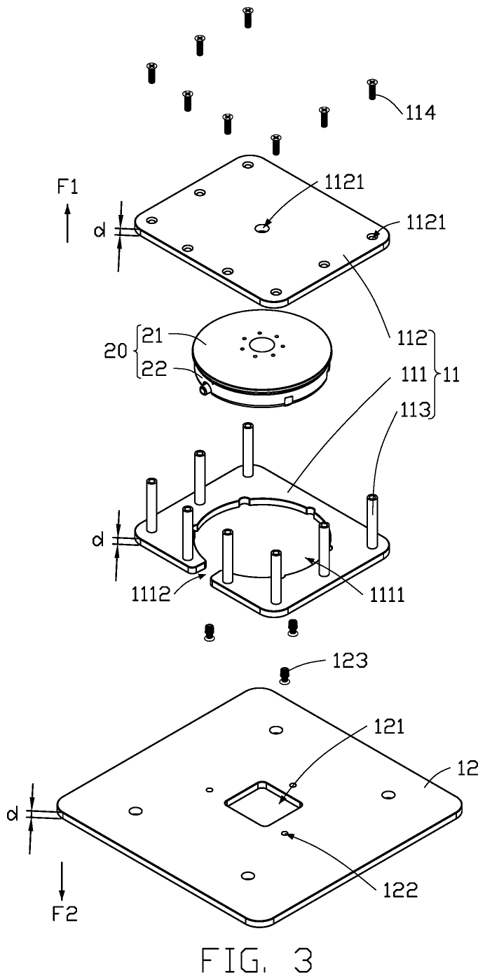

Referring to FIG. 3, the first actuating portion 11 includes a fixing plate 111 and an actuating plate 112 opposite to and fixedly connected to the fixing plate 111.

The fixing plate 111 is substantially a flat plate and defines a first through hole 1111. The first through hole 1111 is used for holding a preset portion of the test object 20 to fix the test object 20. A plurality of connecting posts 113 is mounted on a surface of the fixing plate 111 facing the actuating plate 112, and the plurality of connecting posts 113 is located between the fixing plate 111 and the actuating plate 112. In one embodiment, the connecting posts 113 extend in a direction perpendicular to the surface of the fixing plate 111. The plurality of connecting posts 113 is used for fixing and connecting the fixing plate 111 and the actuating plate 112. Each connecting post 113 is fixedly connected to the actuating plate 112 by a fixing member 114, such as a screw. In one embodiment, each connecting post 113 is integrally formed with the fixing plate 111. In other embodiments, each connecting post 113 is fixed to the fixing plate 111 by a fixing member 123.

The actuating plate 112 is substantially a flat plate. The actuating plate 112 defines a plurality of connecting holes 1121 penetrating the actuating plate 112. A number of the connecting holes 1121 is greater than a number of the connecting posts 113. A same number of the connecting holes 1121 as the connecting posts 1113 are used for setting the fixing members 114, and the remaining number of connecting holes 1121 are used for fixedly connecting the actuating plate 112 to an external tensile tester (not shown). The pulling force F1 applied by the first actuating portion 11 on the test object 20 is measured by the tensile tester. In one embodiment, a number of the connecting holes 1121 for fixedly connecting the tensile tester is one and is located at a center of the actuating plate 112. In one embodiment, there are nine connecting holes 1121, eight connecting posts 113, and eight fixing members 114.

The second actuating portion 12 is substantially flat. A second through hole 121 is defined in the second actuating portion 12. The second through hole 121 is used for receiving the test object 20. The second actuating portion 12 defines a plurality of connecting holes 122. A portion of the connecting holes 122 is used for setting the fixing members 123 to fix the test object 20, and the remaining portion of the connecting holes 122 is used for fixing the second actuating portion 12 to at least one external tensile tester (not shown) for testing the pulling force F2. In one embodiment, two connecting holes 122 are defined in the second actuating portion 12 for fixedly connecting to two tensile testers, respectively. The two tensile testers are connected symmetrically to the second actuating portion 12.

Shapes of the first through hole 1111 and the second through hole 121 are designed to match outer shapes of portions of the test object 20 to be fixed.

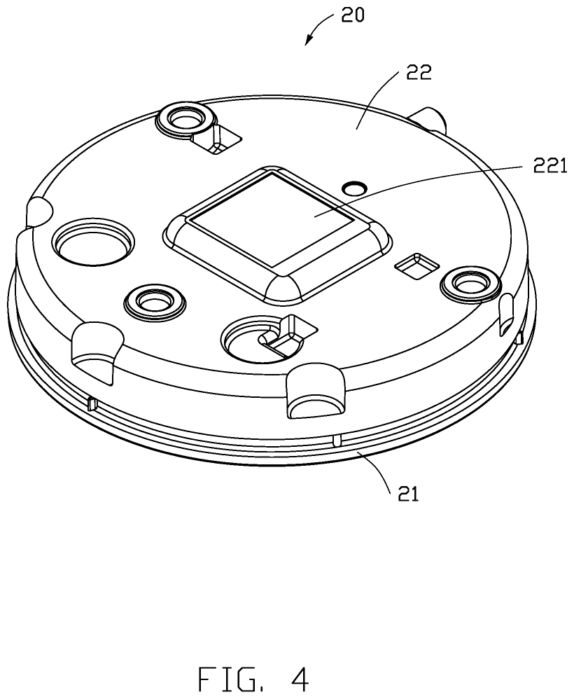

For example, as shown in FIG. 4, the top cover 21 and the bottom cover 22 of the test object 20 are fixedly connected. When the pulling forces F1, F2 are applied, the top cover 21 and the bottom cover 22 are disassembled and separated. The inner diameter of the first through hole 1111 is equal to or slightly larger than the outer diameter of the position where the top cover 21 is fixed. A shape of the top cover 21 is substantially circular, and a shape of the first through hole 1111 is correspondingly substantially circular to tightly fix the top cover 21. In one embodiment, a distance between an inner wall of the first through hole 1111 and the top cover 21 is less than 0.1 mm.

A protrusion 221 is provided on a side of the bottom cover 22 facing away from the top cover 21. Referring to FIGS. 3 and 4, the inner perimeter of the second through hole 121 is larger than the outer perimeter of the protrusion 221, so that when the test object 20 is fixed by the second actuating portion 12, the protrusion 221 of the bottom cover 22 is accommodated in the second through hole 121. A shape of the outer perimeter of the protrusion 221 is substantially rectangular, and a shape of the second through hole 121 is correspondingly substantially rectangular.

In one embodiment, the first actuating portion 11 and the second actuating portion 12 are made of aluminum. In another embodiment, the first actuating portion 11 and the second actuating portion 12 are made of stainless steel for enhancing the tensile strength. In another embodiment, the fixing plate 111 and the second actuating portion 12 are made of elastic materials for accommodating test objects of different shapes and sizes.

In one embodiment, the fixing plate 111 further defines an opening 1112 penetrating one side edge of the fixing plate 111 and communicating with the first through hole 1111. The opening 1112 enhances deformation of the fixing plate 111 for accommodating test objects of different shapes and sizes.

Thicknesses of the fixing plate 111, the actuating plate 112, and the second actuating portion 12 may be equal or different. The thicknesses of the fixing plate 111, the actuating plate 112, and the second actuating portion 12 are defined as d, wherein 2 mm≤d≤4 mm. In one embodiment, the fixing plate 111, the actuating plate 112, and the second actuating portion 12 have the same thickness, d=2 mm. In another embodiment, the thicknesses of the fixing plate 111, the actuating plate 112, and the second actuating portion 12 have the same thickness, d=4 mm. By increasing the thicknesses, the tensile strength of the disassembly device 10 is enhanced.

The disassembly device 10 uses the first actuating portion 11 and the second actuating portion 12 to apply the pulling force F1 and the pulling force F2 in opposite directions to disassemble the test object 20. Compared to the destruction tool in the related art (such as a wrench), it is not easy to damage the test object 20, and the test object 20 can be reassembled and put into use. Therefore, the test fixture 10 is beneficial in prolonging the service life of the test object 20 and saving manufacturing costs.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A disassembly device comprising:
a first actuating portion comprising a fixing plate; and
a second actuating portion separated from the first actuating portion; wherein:
the fixing plate and the second actuating portion fix different portions of a test object;
the test object fixed by the fixing plate and the second actuating portion is located between the fixing plate and the second actuating portion;
the first actuating portion applies a first pulling force on the test object;
the second actuating portion applies a second pulling force on the test object;
the first pulling force is opposite to the second pulling force, and the first pulling force and the second pulling force are configured to disassemble the test object.

2. The disassembly device of claim 1, wherein:
the fixing plate defines a first through hole configured for receiving and fixing the test object.

3. The disassembly device of claim 2, wherein:
the fixing plate further defines an opening communicating with the first through hole.

4. The disassembly device of claim 2, wherein:
the second actuating portion defines a second through hole configured for receiving and fixing the test object.

5. The disassembly device of claim 4, wherein:
shapes of the first through hole and the second through hole match shapes of the portions of the test object to be fixed respectively by the first through hole and the second through hole.

6. The disassembly device of claim 4, wherein:
thicknesses of the fixing plate and the second actuating portion are defined as d; and
2 mm≤d≤4 mm.

7. The disassembly device of claim 1, wherein:
the second actuating portion fixes the test object by a fixing member.

8. The disassembly device of claim 1, wherein:
the first actuating portion comprises an actuating plate fixedly coupled to the fixing plate; and
the first pulling force is applied on the actuating plate.

9. The disassembly device of claim 8, wherein:
the actuating plate is fixedly coupled to the fixing plate by a plurality of connecting posts arranged between the fixing plate and the actuating plate.

10. The disassembly device of claim 9, wherein:
the plurality of connecting posts is integrally formed with the fixing plate.

11. A disassembly device configured for disassembling a test object, the disassembly device comprising:
a first actuating portion configured to fix a portion of the test object and apply a first pulling force on the test object; and
a second actuating portion configured to fix another portion of the test object and apply a second pulling force on the test object; wherein:
the first pulling force is opposite to the second pulling force.

12. The disassembly device of claim 11, wherein:
the first actuating portion comprises a fixing plate defining a first through hole;
the second actuating portion defines a second through hole;
the test object is received and fixed by the first through hole and the second through hole.
